(19) United States
(12) Patent Application Publication
(10) Pub. No.: US 2018/0196866 A1
(43) Pub. Date: Jul. 12, 2018

(54) TOPIC NODES

(71) Applicant: Microsoft Technology Licensing, LLC, Redmond, WA (US)

(72) Inventors: Robert Standefer, V, Duvall, WA (US); Christopher L. Mullins, Sammamish, WA (US); Vyjayanthi Raja, Bellevue, WA (US)

(73) Assignee: Microsoft Technology Licensing, LLC, Redmond, WA (US)

(21) Appl. No.: 15/619,400

(22) Filed: Jun. 9, 2017

Related U.S. Application Data
(60) Provisional application No. 62/443,406, filed on Jan. 6, 2017.

(51) Int. Cl. G06F 17/30

(52) U.S. Cl. CPC G06F 17/30598; G06F 17/3053; G06F 17/30604

(57) ABSTRACT

In non-limiting examples of the present disclosure, systems, methods and devices for triggering contextual feedback related to a manifest are provided. A triggering input related to a contextual trigger may be received. A plurality of attributes associated with a resource may be analyzed. At least one traversable relationship between the resource manifest node may be identified based on the analysis, wherein the traversable relationship is associated with at least one attribute that is shared between the manifest node and the resource. Feedback related to the identified manifest node may be provided.

### BACKGROUND

Data is often uploaded and received by devices and accounts associated with users. Such data may include images, word processing documents, emails, and static documents such as PDFs, among others. Those files may be organized in individual applications or within a file hierarchy for an operating system without respect to events, projects and concepts that they may relate to individually or collectively.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Non-limiting examples of the present disclosure describe systems, methods and devices for triggering contextual feedback related to a manifest. Manifests and manifest nodes related to concepts and events may be created based on analysis of received resources. Manifest nodes and their corresponding attributes may be classified contextually in relation to time, location, concept and/or event. Each of those classifications, and the contextual overlap amongst one or more of those classifications (e.g., contextual overlap for time may be determined based on day, week, working hours, etc.; contextual overlap for location may be based on geolocation hierarchies, areas of distance, etc.), may be utilized to identify relevant information related to a relevant contextual feedback trigger.

Additional resources may be received and their properties may be analyzed to determine whether traversable relationships should be generated between their associated nodes and node attributes and one or more manifest nodes. An indication to provide feedback associated with a manifest and one or more contextual resource may be received and such feedback may be provided to a client device upon determining that a trigger threshold for providing feedback has been met.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system for dynamically linking tasks and resources.

FIG. 2 illustrates an exemplary environment for Set creation from multiple entities having multiple resources.

FIG. 3A illustrates an example isolated collection of asserted resource identifiers and corresponding relationships.

FIGS. 3B-3E illustrate an example query model that may be used to traverse a collection of nodes within a Set.

FIG. 4 illustrates an exemplary environment for triggering contextual feedback related to a manifest.

FIG. 5A illustrates individual contexts for classifying a resource into context groups based on its contextual attributes, and identifying a manifest node having overlapping contextual attributes with the resource.

FIG. 5B illustrates an example manifest node query model that may be used for traversing a relationships between manifest nodes and related resource nodes.

FIG. 6 is an exemplary method for generating traversable contextual relationships between contextual resource nodes and manifest nodes.

FIG. 7 is an exemplary method for triggering contextual feedback related to a manifest.

FIG. 8 illustrates a computing device for executing one more aspects of the present disclosure.

FIG. 9 is a simplified block diagram of a computing device with which aspects of the present disclosure may be practiced.

FIG. 10 is a block diagram illustrating physical components (e.g., hardware) of a computing device 1000 with which aspects of the present disclosure may be practiced.

FIG. 11 is a schematic diagram illustrating an example distributed computing environment for dynamically linking tasks and resources.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems, methods and devices for triggering contextual feedback related to a manifest. As used herein, a “manifest” describes a concept or event which may be associated with one or more contextually-related resources based on various contexts such as time, location and/or associated parties, for example. That is, a “concept manifest” describes the defining features of tasks and projects, and an “event manifest” describes the defining features of events such as trips, meetings, sporting events, and other activities that may be scheduled or attended. Similarly, a “sub-manifest” as it may relate to a concept manifest describes a uniquely identified portion of a concept (e.g., divisions or benchmarks of tasks and projects), and a “sub-manifest” as it may relate to an event manifest describes a uniquely identified portion of an event (e.g., a trip to a country may be identified as a manifest, and individual cities or other geo-entities visited in that country may be identified as sub-manifests).

According to examples, a manifest node may be generated based on an analysis of one or more resources and their corresponding properties. According to other examples a manifest node may be generated based on user input related to one or more received resource and classification of one or more identified events or concepts identified in one or more received resource as corresponding to a manifest. Upon generation of a manifest node additional resources and their corresponding properties may be analyzed and determinations may be made as to whether they are likely to contextually correspond to a manifest and its corresponding manifest node. User input may also be utilized in classifying one or more additional resources and their corresponding properties as being contextually related to a manifest and its corresponding manifest node.

Manifest nodes may be utilized to surface resources, or portions and/or properties thereof, upon receiving a query that references information corresponding to one or more resource that a manifest node represents resource information for (e.g., resource content information, resource metadata, resource attributes, resource format information, resource graphical information, resource textual information, resource audio information, etc.). Manifest nodes and their corresponding attributes and relationships associated with manifest nodes may be defined systematically through computer classification of resource content (e.g, taxonomy classification, hierarchical classification, etc.), and/or by user-defined classification (e.g., individual user tag classification, folksonomy classification, etc.).

Manifest resources and contextual resources may be contextually related if one or more of their properties and corresponding attributes at the node generation level are determined to have one or more shared contextual classifications, including a temporal attribute classification a locational attribute classification, a user-defined concept attribute classification, and a user-defined event attribute classification. For example, one or more resources (and their associated properties) corresponding to generation of a manifest node may be analyzed and determinations may be made regarding whether each property associated with those resources should be classified at the node level as a temporal attribute, a locational attribute, a user-defined concept attribute and/or a user-defined event attribute classification.

An attribute corresponding to a resource property may be classified as a locational attribute based on a determination that its corresponding resource includes information related to the location of an event or concept. For example, a resource may be received which is a flight reservation from City A to City B. In such an example, City A and City B may be classified individually as a locational attributes. Similarly, if a resource is received that is a hotel reservation in City C, City C may be classified individually as a locational attribute.

An attribute corresponding to a resource property may be classified as a temporal attribute based on a determination that its corresponding resource includes information related to a time-sensitive action associated with an event or concept. Referring to the above examples, a resource may be received which is a flight reservation from City A departing at a first time and date and arriving at City B at a second time and date. In such an example, the first and second times and dates may be classified individually as temporal attributes. Similarly, if a resource is received that is a hotel reservation in City C for dates X-Y, dates X-Y may be classified individually as temporal attributes.

An attribute corresponding to a resource property may be classified as a user-defined concept attribute if user input has been received indicating that a resource or a specific property of that resource is related to a concept. For example, if an image resource is received, a user may be prompted to indicate whether that image corresponds to one or more existing manifest concepts or whether a new manifest concept should be created corresponding to that image. In some examples, the user prompt may be provided by an AI bot such as a personal digital assistant. In other examples, the user prompt may be provided via a graphical user interface associated with a manifest and/or a manifest node. In additional examples, a user may be further prompted to answer questions related to a manifest node or a received resource to establish additional context related to a manifest node or a resource such that more meaningful relationships can be established amongst manifest nodes and received resources. According to an example, a user may provide input that classifies resources corresponding to a range of contextual categories as relating to one or more existing manifest concepts, or create new manifest concepts based on input indicating that certain resources or their corresponding properties relate to a particular subset of contexts (e.g., input indicating that all images between time period A are determined to have been taken at specific geolocation B).

Users may classify resources and create relationships that link those resources to one or more manifest node. For example, a user may plan a trip to location A, and input a request to generate a manifest node for the user's trip to location A. Resources relating to the user's trip to location A, and the generated manifest node for the user's trip to location A, may be automatically classified as having a relationship to that manifest node through dynamic computer processing of those resources, and/or by user input indicating that a resource and its corresponding properties and attributes should be associated via one or more relationships to that manifest node. According to some examples, a graphical user interface for linking resources to one or more manifest nodes may be provided to a user such that a user may identify a relevant resource, and create a link between the relevant resource and the one or more manifest nodes. In some examples a user interface for linking resources to one or more manifest nodes may comprise displaying one or more manifest nodes and drag and drop functionality whereby a user may drag and drop a resource onto the one or more manifest nodes to generate resource links to the one or more manifest nodes that the resource has been dragged and dropped onto. In additional examples, by dragging and dropping a resource (or a context node representing a resource) on a manifest node, a user interface may display a graphical relationship between a manifest node and one or more nodes that represent the properties of a resource that has been dragged and dropped on the manifest node.

An attribute corresponding to a resource property may be classified as a user-defined event attribute if user input has been received indicating that a resource or a specific property of that resource is related to an event. For example, if an email is received including an attached PDF of a tourist Visa application for a country, a user may be prompted to indicate whether the email and/or the attached PDF corresponds to one or more existing manifest events or whether a new manifest event should be created corresponding to those resources.

In addition to determining that resources and their corresponding properties and attributes relate to temporal, locational, user-defined conceptual and user-defined event classifications, resources may be classified based on categorical classifications that may be utilized in determining whether they should be associated with manifest resources and nodes. For example, resources and their corresponding properties may be classified according subject matter utilizing machine learning to determine related keywords and phrases that should define analyzed resources. For example, resource images may be analyzed and content within those images may be tagged and otherwise associated with subject matter classifications such as “beach”, “city”, “mountains”, “person A”, “person B”, etc. Additionally, related keywords may also be associated with those classifications such that keyword searching allows a user to locate relevant content related to their searches. For example, if an image has been classified into a “beach” subject matter category, additional words such as “sand”, “ocean” and “water” may be associated with that categorical classification for the image.

According to additional examples, resources and their corresponding properties may be hierarchically categorized based on topical analysis performed from extracted information of resources. Topical analysis may be performed to identify concept categories and event categories that can be assigned to resources, which may be implemented in ranking relational match scores between resources and manifest resources and nodes, as well as determining when a ranked resource or a property of a resource should be provided as feedback in association with locational and temporal data associated with a client computing device.

According to some aspects, when a new resource is received, determinations may be made regarding most relevant manifest nodes corresponding to that resource. For example, a resource and its corresponding property and attribute classifications may be matched against existing manifest node classifications. For example, if a resource and its corresponding property and attribute classifications share one of a temporal or locational attribute classification with a manifest node, that resource may be determined to be potentially related to the manifest node or nodes that it shares those classifications with.

If a resource and its corresponding property and attribute classifications share both temporal and locational attribute classifications with a manifest node, a higher match score may be assigned to that match than a resource that shares just one of temporal or locational classifications with a manifest node. As described above, topical classification weights may also be implemented in determining match relevance scores between resources and manifest nodes. Additionally, locational and temporal classifications for resources that are most closely aligned with manifest node classifications may be implemented to determine most relevant match relevance scores. For example, if a resource has been classified in a temporal classification that matches a first manifest node temporal classification and a second manifest node classification, a determination may be made as to how closely the dates and times of the analyzed temporal properties of the resource match temporal properties of the one or more resources that have been generated into the first and second manifest nodes.

Match relevance scores may be utilized in returning search results that most closely match received queries. For example, queries may contain temporal criteria (e.g., 11 a.m. on Jan. 2, 2017) and locational criteria (beach in Maui), which contextually overlap. As such, information from manifest nodes (and related resource nodes) that most closely matches the contextual criteria contained in the query, as determined based on match relevance scores, may be obtained and provided to a user in response to such a query. Thus, in the above example, if “how many people that live within 2 miles of me were on the same beach when I was there?” is received as a query, the temporal and locational contextual information from that query may be utilized in determining most relevant manifest nodes (and related resource nodes) to access for that information.

According to examples, a user-defined concept or event classification that is shared with a manifest node may be more heavily weighted and/or override any computer-generated ranking of the resource or its corresponding properties and attributes. That is, if user input defines a resource as relating to a specific concept manifest or event manifest, that user-defined classification may provide a match score that is more heavily weighted and/or that automatically outranks a match score for shared temporal and/or locational classifications between resources and manifest nodes.

Traversable relationships between manifest nodes and context nodes (i.e., nodes created based on analysis of new resources) may be created and contextual triggering mechanisms may be implemented to provide feedback related to a context node upon a contextual triggering threshold being met. For example, a user query may be received such as “where am I staying tonight?”. That query may be analyzed in relation to one or more event manifest nodes and a determination may be made that a manifest node corresponds to a current trip that the user is on (e.g., a vacation to Africa that extends over multiple countries in Africa). Upon receiving that query a determination may be made that a main manifest node corresponding to the overall trip corresponds to temporal and locational information extracted from the query (e.g., temporal and locational information extracted from metadata that was associated with the query) and/or sub-manifest nodes corresponding to each country and/or each city that resources associated with the user indicate the user plans to visit may be identified.

Thus, a received user query may be ranked in relation to each manifest node in determining an appropriate response to provide to the user. According to an example, if a sub-manifest node generated from a hotel reservation resource has temporal attributes shared with the received user query (e.g., extracted temporal information for the hotel reservation indicate that the user has a hotel reservation on the same day that the query was received on), a high trigger value may be placed on triggering feedback including information for that sub-manifest node and associated reservation resource.

According to an additional example, if a sub-manifest node generated from a hotel reservation resource has temporal attributes and locational attributes shared with the received user query (e.g., the extracted locational information for the hotel reservation also indicates that the user has a hotel reservation in the same city as geocoded locational coordinates that the received query was received from), a higher trigger value may be provided for triggering feedback including information for that sub-manifest node and associated reservation resource.

According to some examples, a triggering input may be extracted and determined from a user query and locational and temporal data received from a mobile computing device associated with a user may be analyzed in relation to manifest nodes and related contextual nodes. For example, if analysis of received locational and temporal data received from a mobile computing device associated with a user indicate that a user is at an airport on a day corresponding to a locational and temporal classification for an event manifest node (e.g., a manifest node corresponding to a trip the user is taking), one or more contextually related resources and their corresponding nodes may be identified as being relevant to the user at that time and location and a triggering event may occur. For example, a contextual node related to the user's travel event manifest may identify a flight boarding pass resource for the user that may be used to board a flight to the user's destination.

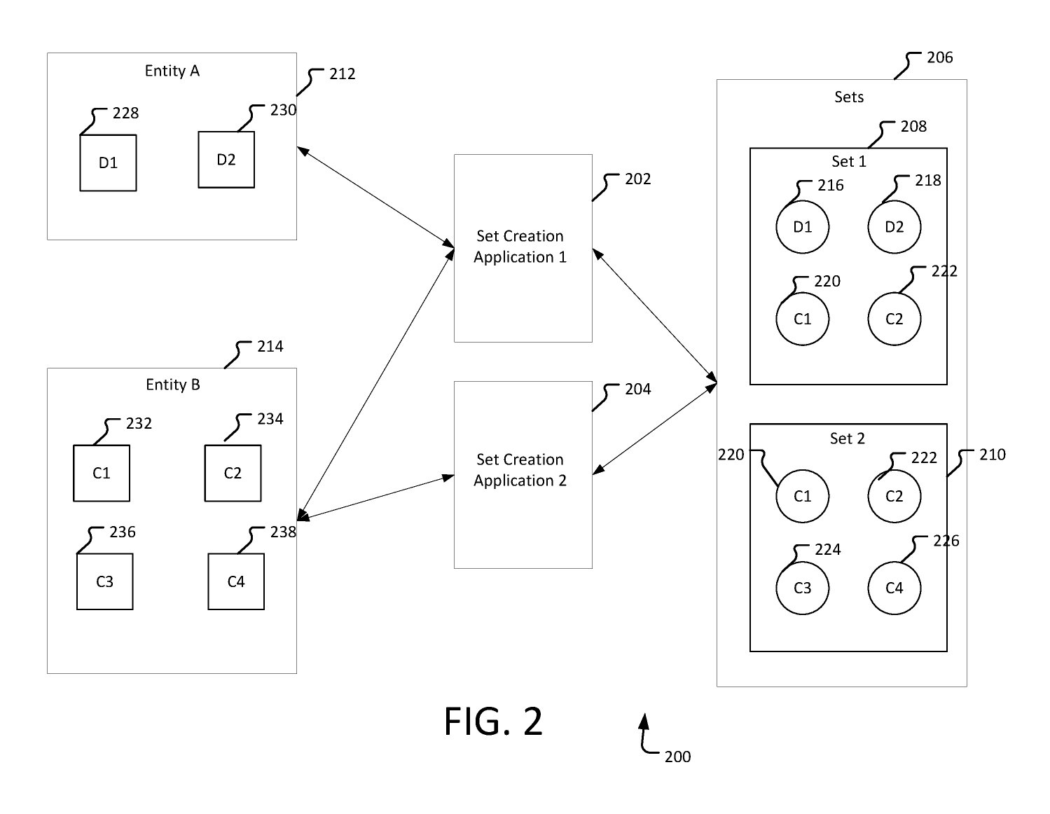

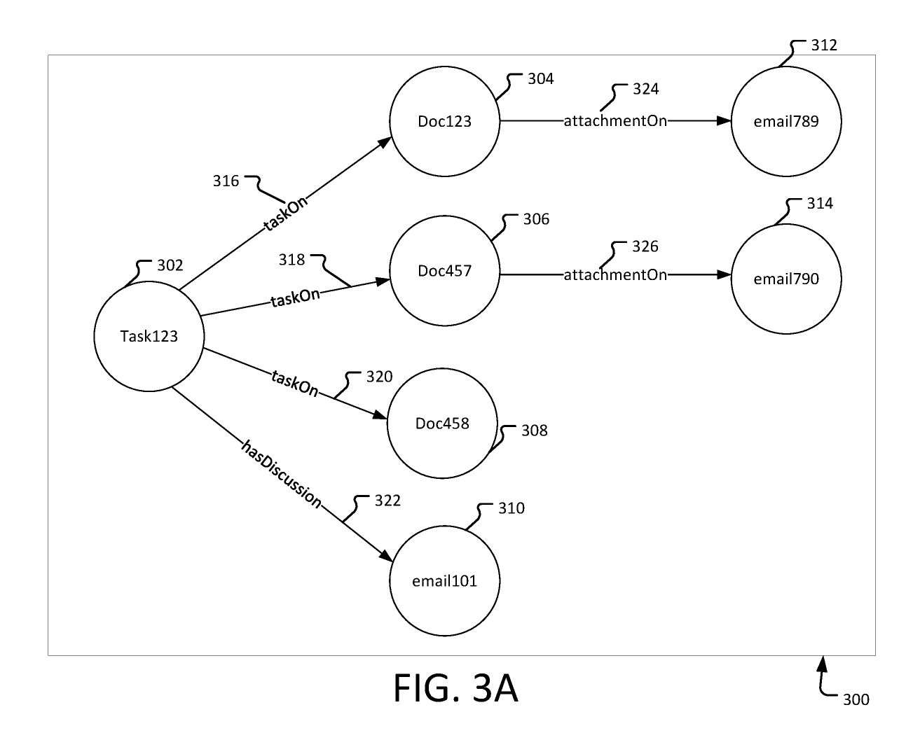

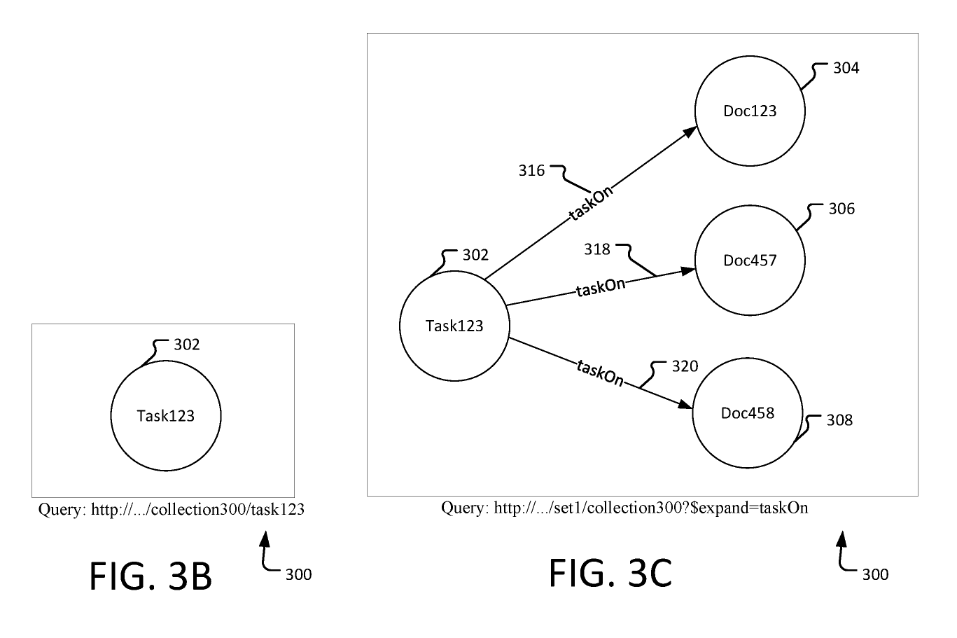

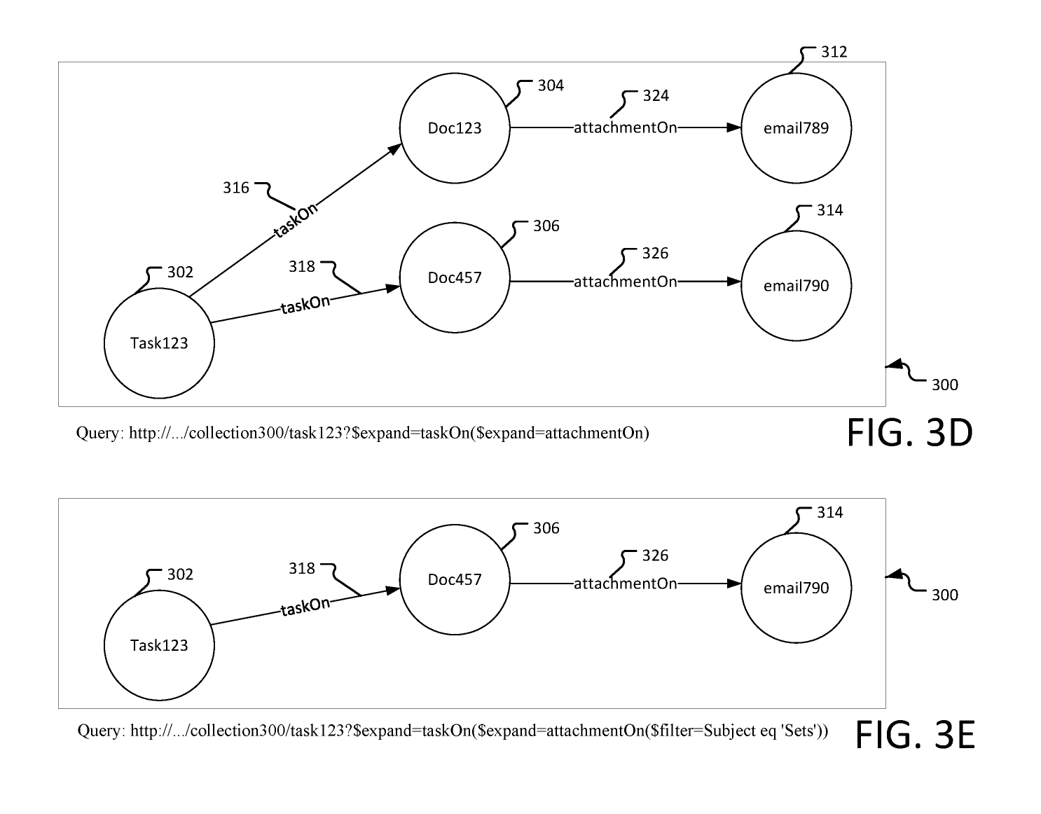

Various data structures may be employed to represent manifests and relationships between manifests and resources. For example, a linked list or a relational database may be used to store information about or relating to manifests. Alternatively, a graph, also referred to herein as a Set, may be used to represent various manifests and their relationships to contextually related resources. Additional information regarding the creation and use of a Set will be provided below with respect to FIGS. 2 and 3.

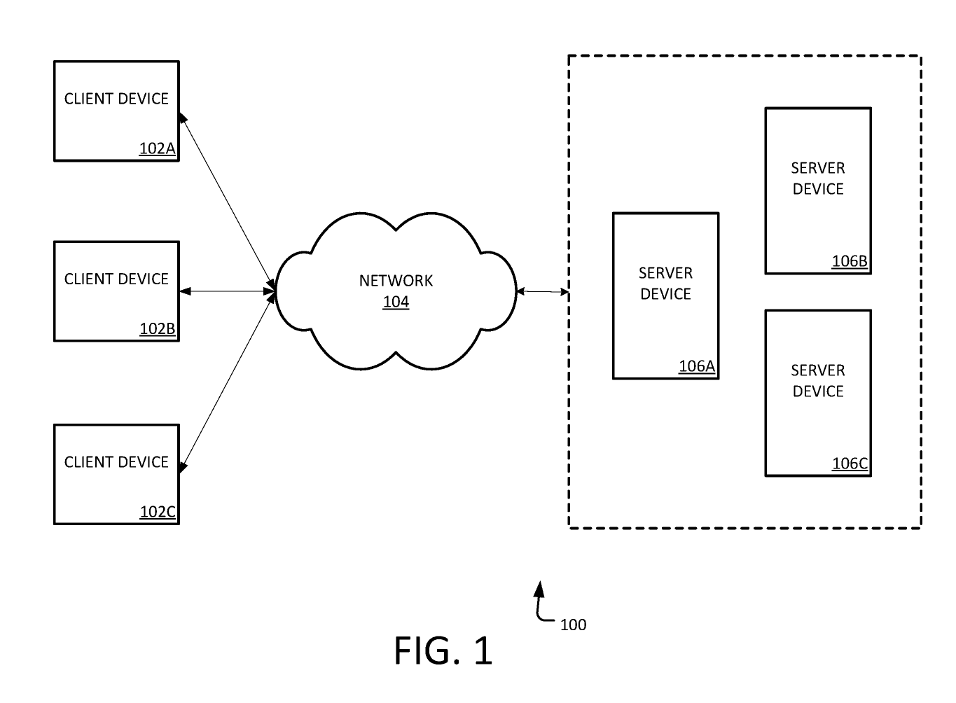

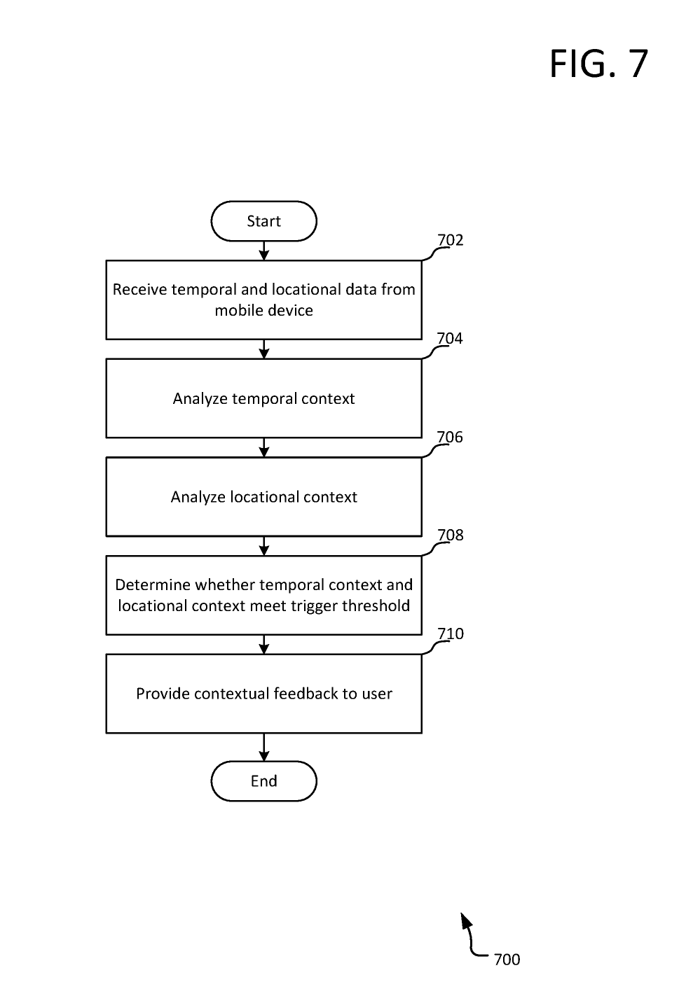

FIG. 1 illustrates an overview of an example system 100 for dynamically linking tasks and resources. Example system 100 may be a combination of interdependent components that interact to form an integrated whole for performing delegated authentication. In aspects, system 100 may include hardware components (e.g., used to execute/run operating system (OS)), and/or software components (e.g., applications, application programming interfaces (APIs), modules, virtual machines, runtime libraries, etc.) running on hardware. In particular aspects, system 100 may provide an environment for software components to execute, evaluate operational constraint sets, and utilize resources or facilities of the system 100. In such aspects, the environment may include, or be installed on, one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic device. As an example of a processing device operating environment, refer to the exemplary operating environments depicted in FIGS. 7-11. In other instances, the components of systems disclosed herein may be distributed across and executable by multiple devices. For example, input may be entered on a client device and information may be processed or accessed from other devices in a network (e.g. server devices, network appliances, other client devices, etc.).

As presented, system 100 comprises client devices 102A-C, distributed network 104, and a distributed server environment comprising one or more servers, such as server devices 106A-C. One of skill in the art will appreciate that the scale of systems such as system 100 may vary and may include additional or fewer components than those described in FIG. 1. In some aspects, interfacing between components of the system 100 may occur remotely, for example, where components of system 100 may be distributed across one or more devices of a distributed network.

In aspects, client devices 102A-C may be configured to receive input via a user interface component or other input means. Examples of input may include voice, visual, touch and text input. The interface component may enable the creation, modification and navigation of various data sets and graphical representations. In examples, the various datasets may comprise (or be otherwise associated with), for example, resource identifiers, resource metadata, relationship information, asserted relationships, graphical mapping information, query data, rule sets, such as, for example, inference rules, authorization information, authentication information, etc., as discussed in further detail below. Generally, the datasets are stored on one or more server devices 106A-C and are accessible by the client devices 102A-C. In some examples, however, the datasets may be at least partially stored on one or more of the client devices 102A-C. The underlying resources represented in the various datasets may be stored locally or in a data store, such as a cloud storage application, accessible to client devices 102A-C. In at least one example, the underlying resources represented in the various datasets (or portions thereof) may be distributed across client devices 102A-C. For instance, client device 102A (e.g., a mobile phone) may locally store a first portion of the resources represented in the dataset, client device 102B (e.g., a tablet) may locally store a second portion of the resources, and client device 102C (e.g., a laptop) may locally store the remaining portion of the resources represented in the dataset. In examples, the client devices 102A-C may have access to all of the resources included in the data set, may have access to a subset of the resources included in the dataset, or, alternatively, may not have access to any of the resources included in the dataset.

Client devices 102A-C may be further configured to interrogate data stores comprising the resources corresponding to the resource identifiers in the various data sets. In examples, client devices 102A-C may interrogate content providers, such as server device 102A-C, via distributed network 104. The interrogation may include identifying the remote device on which a resource is located, and/or determining whether the remote device (or a service/separate remote device) has authenticated access to the resource. If access to the resource has been authenticated, client devices 102A-C may retrieve an authentication indication from the remote device. Client devices 102A-C may use the authentication indication to provide access to one or more of the various datasets comprising the corresponding resource identifier.

Server devices 106A-C may be configured to store and/or provide access to one or more resources. For example, server device 102A may be a web server, server device 102B may be a device comprising a collaborative messaging tool and a calendaring application, and server device 102C may be electronic mail server. Each of these devices may comprise a repository of resources that is accessible via one or more authentication mechanisms. In examples, server devices 106A-C may perform or monitor the authentication process when a request for a resource is received. If the authentication is successful, the authenticating device may store or maintain an authentication indication for a specified period of time. When the period of time expires, server devices 106A-C may remove or attempt to renew the authentication indication. In examples, server devices 106A-C may provide the authentication indication to an interrogating client device. In some aspects, server devices 106A-C may further be configured to store at least a portion of the various data sets and graphical representations, as discussed above.

FIG. 2 illustrates an overview of an example system 200 for managing isolated collections of resource identifiers and corresponding relationships. The isolated collection techniques implemented in system 200 may comprise or be associated with one or more of the delegated authentication techniques described in FIG. 1. In alternative examples, a single device (comprising one or more components such as processor and/or memory) may perform the processing described in systems 100 and 200, respectively.

With respect to FIG. 2, system 200 may comprise Set creation applications 202 and 204, Set environment 206, Sets 208 and 210, entities 212 and 214, resources identifiers 216, 218, 220, 222, 224 and 226, and resources 228, 230, 232, 234, 236 and 238. In aspects, Set creation applications 202 and 204 may be an application or service configured to create, infer, manipulate, navigate and visualize various resources, relationships and graphical representations. Set creation applications 202 and 204 may define collections of relationships between resources (e.g., people, files, tasks, mail, documents, calendar events, etc.) and executing queries on those collections. Set creation applications 202 and 204 may further provide for defining and storing rule sets used to infer one or more relationships in the collections, and displaying graphical representations of the collection data. The defined rulesets may be stored in the Set itself, and in some examples is stored as metadata within the Set. In examples, Set creation applications 202 and 204 may be installed and executed on a client device or on one or more devices in a distributed environment. For instance, Set creation application 202 may be installed on client device 102A, Set creation application 204 may be installed on client device 102B, and a Set creation service associated with server device 106A may be accessible to client device 102C.

In aspects, Set creation applications 202 and 204 may have access to a file directory or an execution environment, such as environment 206. Environment 206 may be co-located with a Set creation application, or environment 206 may be located remotely from the Set creation application. Environment 206 may provide access to one or more data collections, such as Sets 208 and 210. In examples, access to the data collections may be determined using one or more sets of permissions generated and/or maintained by Set creation applications 202 and 204. The sets of permissions may be different across one or more of the data collections. As a result, one or more of the data collections (or functionality associated therewith) may not be accessible from one or more of Set creation applications 202 and 204.

Sets 208 and 210 may respectively comprise isolated collections of asserted resource identifiers and corresponding relationships. The relationships in the isolated collections may be defined manually or may be automatically derived using one or more rule sets. The isolated collections may be represented using graphical structures that directly relate resources in the data collection and provide for retrieving relationship data with a single operation. Each isolated collection may comprise resource identifiers that are unique to that isolated collection. Alternately, the isolated collections may comprise resource identifiers included in one or more alternate isolated collections. For example, as depicted in FIG. 2, Set 208 may comprise resource identifiers 216, 218, 220 and 222, and Set 210 may comprise resource identifiers 220, 222, 224 and 226. Resource identifiers 216, 218, 220, 222, 224 and 226 may correspond to, and/or identify the location of, one or more resources. As used herein, a resource identifier references an existing resource, but is not itself a resource. Exemplary types of resource identifiers include, but are not limited to, a Uniform Resource Identifier (e.g., a Uniform Resource Locator (URL), a Uniform Resource Name (URN) etc.), an IP address, a memory or storage address, and the like. One of skill in the art will appreciate that any type of identifier may be employed by the various aspects disclosed herein without departing from the scope of this disclosure. Identifying the location of a resource may include parsing the resource identifier using, for example, regular expressions, providing one or more portions of the resource identifier to a search utility, executing the resource identifier, etc. In aspects, having access to the data collections does not guarantee access to the resources identified by the resource identifiers included in each data collection. For example, although a user may be able to access and manipulate Set 208, the user may not be authorized to access one or more of the underlying resources corresponding to the resource identifier in Set 208.

Resource providers 212 and 214 may be configured to store and/or provide access to one or more resources. As such, a resource provider as used herein may be a data store, a cloud service provider, a client computing device, a server computing device, a distributed system of devices, such as, for example, an enterprise network, an application, a software platform (e.g., an operating system, a database, etc.), and the like. In aspects, resource providers 212 and 214 may be (or have access to) various different data sources, such as content providers, data stores, various sets of application data, and the like. The data stores may comprise one or more resources corresponding to one or more resource identifiers. For example, as depicted in FIG. 2, resource provider 212 may be a data store comprising various different types of resources such as resource 228 (e.g., document 1 (D1)) and resource 230 (e.g., presentation 2 (P1)) and resource provider 214 may be a contact management application comprising contact resources 232 (e.g., contact 1 (C1)), 234 (e.g., contact 2 (C2)), 236 (e.g., contact 3 (C3)) and 238 (e.g., contact 4 (C4)). In this example, resource identifier 216 may correspond to resource 228; resource identifier 218 may correspond to resource 230; resource identifier 220 may correspond to resource 232; resource identifier 222 may correspond to resource 234; resource identifier 224 may correspond to resource 236; and resource identifier 226 may correspond to resource 238. In some aspects, resource providers 212 and 214 may be accessible by Set creation applications 202 and 204. Set creation applications 202 and 204 may access resource providers 212 and 214 to determine the existence of resources and/or retrieve information associated with the resources (e.g., resource metadata, resource location, resource identifiers, permission sets, authentication data, etc.). The information retrieved from resource providers 212 and 214 may be used to determine a set of resource identifiers corresponding to one or more of the available resources. The set of resource identifiers may be used to create one or more isolated collections of asserted resource identifiers and corresponding relationships. As noted above, the resource identifiers may be, or include, a durable URI for its corresponding resource. For instance, the resource identifier 216 may include the URI for the actual document (D1) 228. Accordingly, in such an example, a user is able to determine the location of the document (D1) 228 from the Set, and, depending on authentication and access restrictions, retrieve the document (D1) 228. As another example, as depicted in FIG. 2, resource provider 212 may be accessed by Set creation application 202. Set creation application 202 may determine that resource provider 212 comprises at least resources 228 and 230, and may determine resource identification information for each of the resources. Based on the determined resource identification information, resource identifiers 216 and 218 may be respectively applied/correlated to resources 228 and 230, and provided to environment 206. Environment 206 may then make resource identifiers 216 and 218 eligible for an inclusion analysis into one or more isolated collections.

FIG. 3A illustrates an example isolated collection 300 of asserted resource identifiers and corresponding relationships. Example isolated collection 300 comprises resource identifiers 302, 304, 306, 308, 310, 312 and 314, and relationships 316, 318, 320, 322, 324 and 326. In aspects, isolated collection 300 may be generated and/or manipulated using a collection creation utility that may be included as part of a Set creation application as discussed above. When presented in graph form as depicted in the FIG. 3A, each resource identifier may be referred to as a “node” and each relationship may be referred to as an “edge.” The collection creation utility may also identify resources and/or determine resource types for collections using one or more rule sets that may include rules defined in accordance with semantic web technologies, such as resource description framework (RDF), RDF schema (RDFS), SPARQL Protocol and RDF Query Language (SPARQL), Web Ontology Language (OWL), etc. For example, collection 300 includes a resource identifier 312 that represents an underlying resource, “email789” in the depicted example. Similarly, resource identifier 304 represents a resource document, “Doc123,” and resource identifier 302 represents a resource task, “Task123.” Each of the resources and relationships included in the isolated collection 300 may have been asserted by a developer through a Sets creation application. For instance, a developer may manually add each of the resource identifiers and the relationships between the resource identifiers. As an example, the developer may manually indicate that the “task123” is a task on “Doc123,” as represented in the collection 300 by the “taskOn” relationship 316. The resource identifiers and relationships may also be asserted by an external bot or application created by a developer. For instance, an add-in may be programmed to monitor activity in a browser or other application to track usage of the application. Based on the usage of the application, the add-in sends additional resources and relationships to be included in the collection 300.

In contrast to the asserted resource identifiers and relationship, a collection creation utility may execute a ruleset to determine additional relationships and resource types, referred to herein as “inferred relationships” and “inferred resource identifiers” or “inferred resource types.” For example, upon execution of a ruleset, the collection creation utility may determine that resource identifier 312 represents an email message, and resource identifier 304 represents a document. Generation of inferred relationships and resources is discussed in further detail below.

Isolated collection 300 further depicts that resource identifier 302 is associated with resources identifiers 304, 306 and 308 and resource identifier 310. The collection creation utility may determine that the resource identifier 302 represents a task to be performed on identifiers 304, 306, and 308. Based on this determination, the collection creation utility may assign relationships 316, 318 and 320 (e.g., “taskOn”) to define the association between resource identifier 302 and resource identifier 304, 306 and 308. In other examples, the relationships 316, 318, and 320 may be asserted, as discussed above. Additional relationships, such as the “hasDiscussion” relationship 322 may have been asserted manually by a developer or asserted from an add-in of an e-mail application that analyzed the content of e-mail 101. While specific types of resources and relationships are described in FIG. 3A, one of skill in the art will appreciate that other types of resources and/or relationships may be included in an isolated collection without departing from the spirit of this disclosure.

FIGS. 3B-3E illustrate an example query model that may be used to traverse collection 300. In aspects, queries may be executed via an interface provided by the collection creation utility. A query may be executed against one or more files and/or directories comprising information, such as resource identifiers, resource type, resource metadata, permission data, etc. The query results may be visualized in a graph form as one or more collections, such as collection 300. For example, the entire collection 300 dataset may comprise only those elements illustrated in collection 300 (e.g., resource identifiers 302, 304, 306, 308, 310, 312 and 314 and relationships 316, 318, 320, 322, 324 and 326). In this particular example, resource identifier 312 may represent an email comprising the subject “API Design” and resource identifier 314 may represent an email comprising the subject “Sets.” The query ‘http://.../collection300/task123’ may be executed against collection 300. The query results may comprise resource identifier 302 and be visualized as illustrated in FIG. 3B. In FIG. 3C, the query has been amended to ‘http://.../collection300/task123?$expand=taskOn’ and executed against collection 300. The query results may comprise resource identifiers 302, 304, 306 and 308 and relationships 316, 318 and 320, and be visualized as illustrated in FIG. 3C. In FIG. 3D, the query has been amended to ‘http://.../collection300/task123?$expand=taskOn($expand=attachmentOn)’ and executed against collection 300. The query results may comprise resource identifiers 302, 304, 306, 308, 312 and 314 and relationships 316, 318, 320, 324 and 326, and be visualized as illustrated in FIG. 3D. In FIG. 3E, the query has been amended to ‘http://.../collection300/task123?$expand=taskOn($expand=attachmentOn($filter=Subject eq ‘Sets’))’ and executed against collection 300. As only resource identifier comprises 314 the subject “Sets”, the query results may comprise resource identifiers 302, 306 and 314 and relationships 318 and 326, and be visualized as illustrated in FIG. 3E.

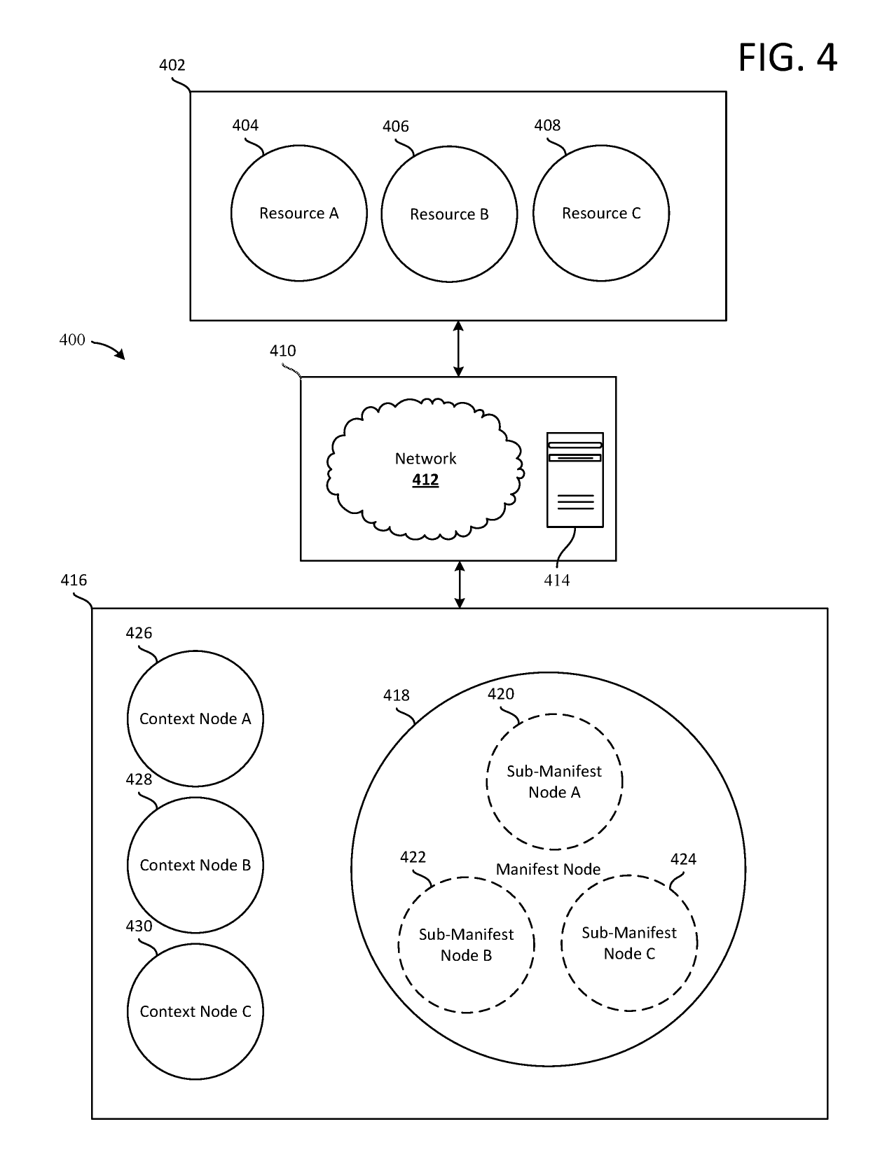

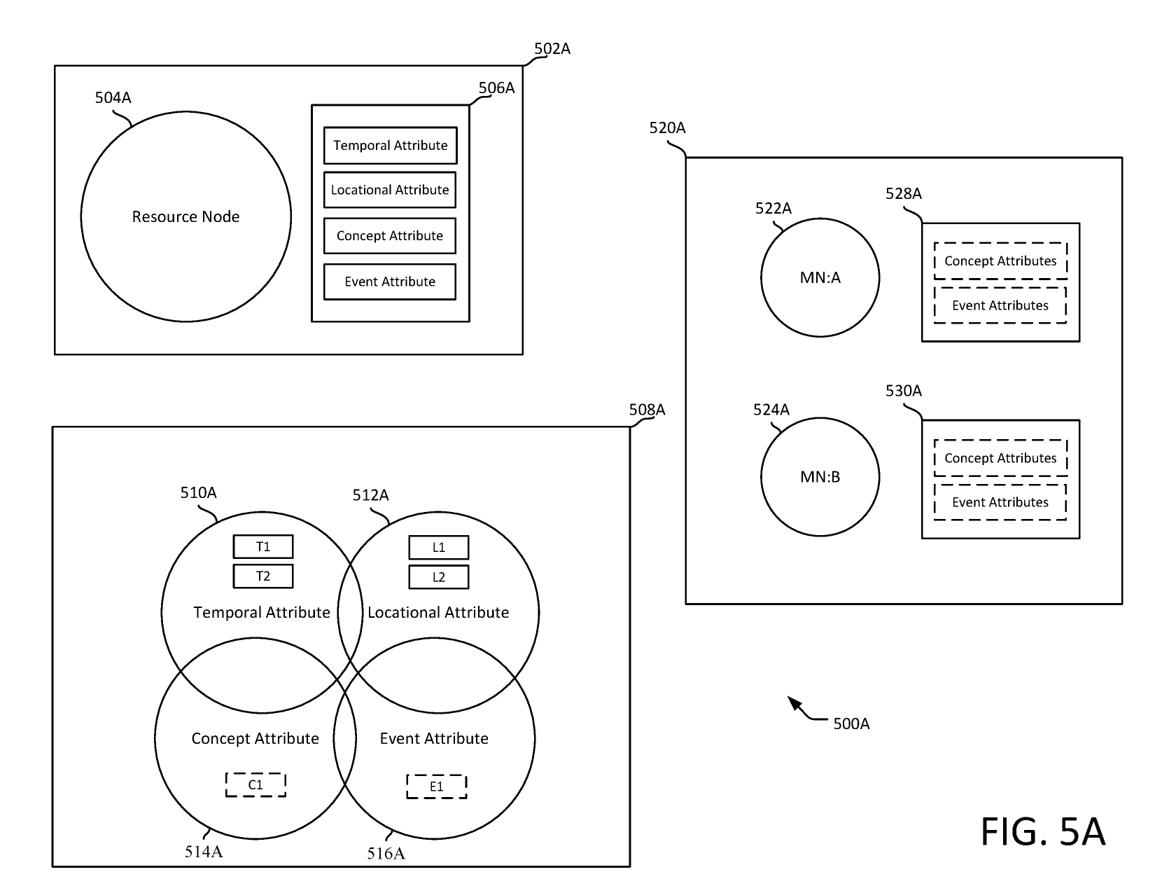

FIG. 4 illustrates an exemplary environment 100 for triggering contextual feedback related to a manifest. Exemplary environment 100 includes resource context 402, resource processing and analysis context 410, and contextual node ranking context 416.

Resource context 402 includes resources 404, 406 and 408, which may include data formats such as image files, document files, word processing files, static image files, audio files, video files, and the like, which may be associated with a user client device or an account associated with a user.

Resource processing and analysis context 410 includes network 412, by which one or more of resources 404, 406 and 408 may be received, and one or more computing devices, such as server computing device 414 that may be utilized to process and analyze properties of received resources. For example, server computing device 414 may perform image processing operations, character recognition operations, voice analysis operations, etc. on received resource properties. According to some examples, received resource content, including the results of the resource processing, may be stored in one or more formats such that the resources may be queried as part of a graph structure. Resource information including resource structure and resource formatting may also be stored for querying as part of a graph structure. Server computing device 414 may further process the processed resource information to determine whether one or more traversable relationships between nodes for those resources and corresponding properties and node attributes should be created linking them to one or more manifest nodes or sub-nodes upon a contextual triggering mechanism.

Contextual node ranking context 416 includes context node A 426, context node B 428, and context node C 40, as well as manifest node 418, sub-manifest node A 420, sub-manifest node B 422, and sub-manifest node C 424. Traversable relationships may be generated between each of context nodes 426, 428 and 430 between themselves and manifest and sub-manifest nodes 418, 420, 422, and 424 such that context nodes that share one or more contextual classifications and/or topical hierarchical classifications with the manifest nodes may be triggered based upon relevant temporal and/or locational input being received.

According to an example, manifest node 418 may correspond to a trip to Africa, sub-manifest node A 420 may correspond to a sub-trip to South Africa, sub-manifest node B may correspond to a sub-trip to Mount Kilimanjaro, and sub-manifest node C may correspond to a sub-trip to Kenya.

Context node A 426 may correspond to information associated and processed in resource processing and analysis context 410 in relation to resource A 404. Context node B 428 may correspond to information associated and processed in resource processing and analysis context 410 in relation to resource B 406. Context node C 430 may correspond to information associated and processed in resource processing and analysis context 410 in relation to resource C 408.

Thus, according to the example above, resource A 404 may be a country Visa application for one or more countries relating the user's Africa trip (corresponding to manifest node 418), resource B 406 may be vaccination records for one or more countries relating to the user's Africa trip, and resource C 408 may be hotel reservations for one or more cities and countries relating to the user's Africa trip.

Each of context nodes 426, 428 and 430 may be determined in resource processing and analysis context 410 to have contextual attribute classifications corresponding to classifications for attributes of manifest nodes 418, 420, 422 and 424. A match value may be assigned to each of those relationships and feedback triggering rankings may be associated with each of context nodes 426, 428 and 430. The feedback triggering rankings may be utilized in determining what locational and/or temporal input must be received in order to trigger feedback relating to one or more of context nodes 426, 428 and 430.

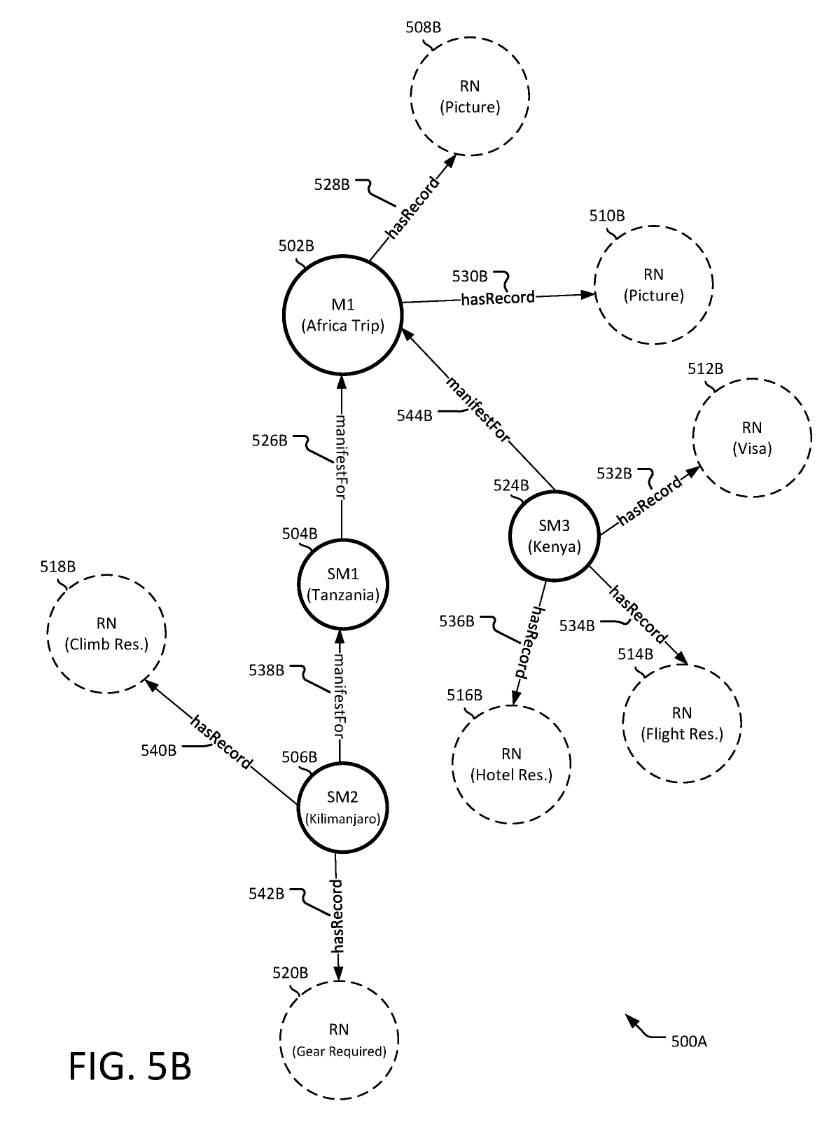

FIG. 5A illustrates an exemplary environment 500A for triggering contextual feedback related to a manifest. Exemplary environment 500A includes individual contexts 502A, 508A and 520A for classifying a resource into context groups based on its contextual attributes, and identifying a manifest node having shared contextual attribute classifications with the resource.

Resource context 502A includes resource node 504A corresponding to a processed resource, as well as contextual attribute category classifications 506A, which may be assigned to one or more attributes associated with resource node 504A. Contextual attribute category classifications 506A include temporal attribute classification, locational attribute classification, concept attribute classification (e.g., user-defined concept attribute classification), and event attribute classification (e.g., user-defined event attribute classification).

Attribute classification context 508A includes temporal attribute classification 510A, locational attribute classification 512A, concept attribute classification 514A and event attribute classification 516A. According to this example, temporal attribute classification 510A includes time 1 and time 2, each of which may be associated with a property associated with resource node 504A. For example, time 1 and time 2 may relate to dates and/or times extracted and determined from analysis and processing of resource node 504A (e.g., if resource node 504A corresponds to a hotel reservation, T1 may indicate a date and time of check-in for that hotel reservation and T2 may indicate a date and time of checkout for that hotel reservation).

Locational attribute classification 512A includes location 1 and location 2, each of which may be associated with a property associated with resource node 504A. For example, location 1 and location 2 may relate to geolocations and/or determined corresponding points of interest extracted and determined from analysis of locational coordinates determined from analysis and processing of resource node 504A (e.g., if resource node 504A corresponds to a flight reservation, L1 may indicate an airport location of departure and L2 may indicate an airport location of arrival).

Concept attribute 514A includes a concept attribute classification. For example, a concept classification may be machine generated during analysis and processing of properties associated with resource node 504A. Alternatively, concept classification may be user-provided. For example, concept attribute classification C1 may be made based on receiving resource node 504A and receiving user input indicating that resource node 504A and/or one or more of its properties should be classified as being related to a specific manifest and corresponding manifest node (e.g., if resource node 504A corresponds to a specific work project manifest, a user may provide input indicating that the resource node 504A should be classified as relating to that specific work project manifest).

Event attribute 516A includes an event attribute classification. For example, an event classification may be machine generated during analysis and processing of properties associated with resource node 504A. Alternatively, concept classification may be user-provided. For example, event attribute classification E1 may be made based on receiving resource node 504A and receiving user input indicating that resource node 504A and/or one or more of its properties should be classified as being related to a specific manifest and corresponding manifest node (e.g., if resource node 504A corresponds to travel document for a specific travel manifest, a user may provide input indicating that the resource node should be classified as relating to that specific travel manifest).

Manifest attribute context 520A includes manifest node A 522A with related attribute classifications 528A, as well as manifest node B 524A and related attribute classifications 530A. Manifest node A 522A and manifest node B 524A each have one or more attributes which have been designated as relating to at least one of a concept attribute classification or an event attribute classification. Additionally, each of those classifications may relate to one or more of a temporal attribute classification, and a locational attribute classification attribute, and those classifications may further be associated with a hierarchical topical categorization.

FIG. 5B illustrates an example manifest node query model 500B that may be used for traversing relationships between manifest nodes and related resource contextual nodes. The example manifest node query model 500B illustrates a graph, or Set, comprising manifest node M1 502B (Africa Trip), sub-manifest node SM1 504B (Tanzania), sub-manifest node SM2 506B (Kilimanjaro), and sub-manifest node SM3 524B (Kenya), as well as related resource nodes 508B, 510B, 512B, 514B, 516B, 518B, and 520B, that have one or more relationships assigned to a corresponding manifest and/or sub-manifest node.

According to examples, manifest node M1 502B may be generated based on processing and analysis of one or more resources corresponding to an event, such as a trip that a user is planning to Africa. In other examples, manifest node M1 502B may be generated as a shell manifest node based on a user interaction to generate a node for which the user may anticipate resources will eventually be linked to via one or more relationships. Sub-manifest nodes 504B, 506B, and 524B may be generated and linked to manifest node 502B subsequent to the generation of manifest node 502B based on one or more related resources being processed and analyzed (e.g., resources having properties related to the user's travel to Tanzania, Kilimanjaro, and Kenya). Alternatively, sub-manifest nodes 504B, 506B, and 524B may be generated as shell sub-manifest nodes based on a user interaction to generate a node for which the user may anticipate resources will eventually be linked via one or more relationships.

Resources and corresponding resource properties for each of the nodes depicted in example manifest node query model 500B may be analyzed and relationships may be assigned to nodes within example manifest node query model 500B such that the Set, or a corresponding computing device, may process queries related to the manifest and sub-manifest nodes of the Set based on those relationships. For example, the relationships Manifest for 526B, 538B, and 544B may be assigned to the corresponding manifest and sub-manifest nodes in example manifest node query model 500B for processing queries related to those nodes. In a specific example, the manifest node M1 502B (Africa) has a relationship 526B between itself and sub-manifest node SM1 504B (Tanzania), the manifest node M1 502B (Africa) has a relationship 544B between itself and sub-manifest node SM3 524B (Kenya), and sub-manifest node SM1 504B has a relationship 538B between itself and sub-manifest node SM2 506B (Kilimanjaro).

In the example manifest node query model 500B, resource nodes 508B and 510B may have attributes that link them to manifest node M1 502B via one or more classification, such as a temporal classification, a locational classification, a concept classification, and/or an event classification. For example, resource nodes 508B and 510B may correspond to pictures that a user took on the user's Africa trip and locational and/or temporal metadata associated with those pictures may be analyzed and the relationships 528B and 530B (hasRecord) between manifest node 502B and resource nodes 508B and 510B may be assigned to the Set. In other examples, a user may manually create the relationships 528B and 530B (hasRecord) between the resource nodes and manifest node 502B. For example, a user may select a photo in a photo application on a computing device and manually indicate that the picture should be associated with the user's Africa trip in a Set, such as the Set depicted in manifest node query model 500B.

Similarly, resource nodes 512B, 514B, and 516B may have attributes that link them to manifest node SM3 524B via one or more classification, such as a temporal classification, a locational classification, a concept classification, and/or an event classification.

Resource node 512B may correspond to a visa document that a user received for her trip to Kenya and one or more analyzed properties of that visa may be determined to correspond to an attribute of the Kenya sub-manifest node 524B. The hasRecord 532B relationship may thus be assigned to those nodes.

Resource node 514B may correspond to a flight reservation document that a user received for her trip to Kenya and one or more analyzed properties of that flight reservation may be determined to correspond to an attribute of the Kenya sub-manifest node 524B. The hasRecord 534B relationship may thus be assigned to those nodes.

Resource node 516B may correspond to a hotel reservation document that a user received for her trip to Kenya and one or more analyzed properties of that hotel reservation may be determined to correspond to an attribute of the Kenya sub-manifest node 524B. The hasRecord 536B relationship may thus be assigned to those nodes.

Resource node 520B may correspond to a document that was received by the user that indicates that certain gear is required for climbing Mt. Kilimanjaro and one or more analyzed properties of that document may be determined to correspond to an attribute of the Kilimanjaro sub-manifest node 506B. The hasRecord 542B relationship may thus be assigned to those nodes.

Resource node 518B may correspond to a reservation document for climbing Mt. Kilimanjaro and one or more analyzed properties of that reservation document may be determined to correspond to an attribute of the Kilimanjaro sub-manifest node 506B. The hasRecord 540B relationship may thus be assigned to those nodes.

Although certain relationships amongst nodes in example manifest node query model 500B are described as “hasRecord” relationships, other relationship types may be assigned to nodes that are determined to be related based on one or more corresponding attributes and/or user-assigned classifications (e.g., taskOn relationships, attachmentOn relationships, etc.) according to resource and graph application requirements and needs, thereby facilitating a richer querying experience and enhancing machine processing of a plurality of query types and user-specific needs.

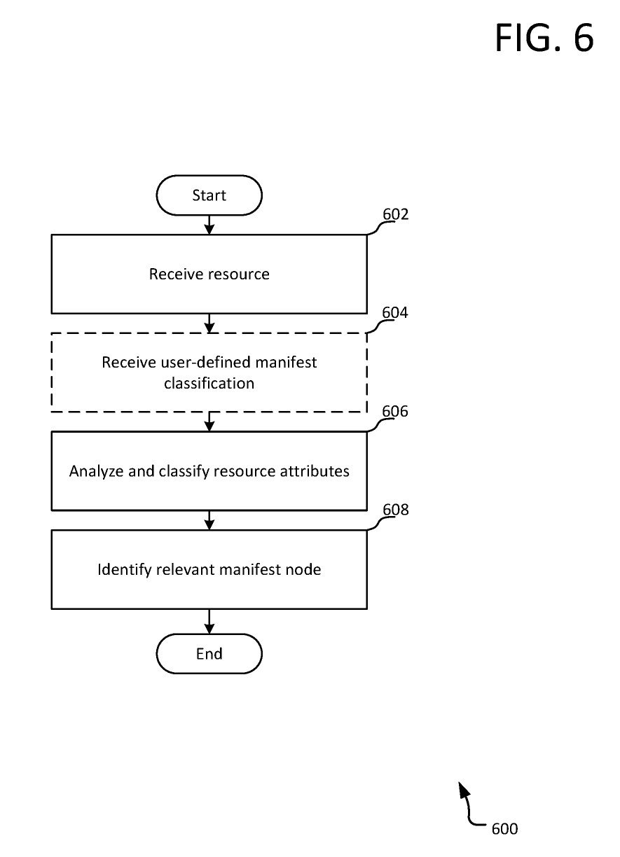

FIG. 6 is an exemplary method 600 for generating traversable contextual relationships between contextual resource nodes and manifest nodes. The method 600 begins at a start operation and continues to operation 602 where a resource is received. For example, data associated with a user, a user device and/or an account associated with a user device or user credentials related to images, emails, documents, audio files, video files, static image files, etc., may be received by a computing device such as the server computing device 414 illustrated in FIG. 4.

Moving from operation 602 flow continues to operation 604 where user input may be received which defines one or both of a concept manifest classification and an event manifest classification for one or more of the properties associated with the received resource. For example, when a resource is received, a user may be prompted to indicate whether the resource or properties of that resource relate to an existing manifest or whether a new manifest should be generated for the resource.

Moving from operation 604 flow continues to operation 606 where one or more properties of the received resource may be analyzed and processed. For example, character recognition analysis, natural language processing, image recognition analysis, geo-location analysis, and other data processing operations may be performed on the resource, which may be used to classify each property of the resource into contextual classification categories including temporal classification, locational classification, concept attribute classification, and event attribute classification, as well as hierarchical topical classification.

From operation 606 flow continues to operation 608 where one or more manifest nodes related to the received resource are identified. In identifying whether a manifest node relates to the received resource property classification (or attribute classification for a node generated for the received resource property), property classifications of the received resource may be analyzed to determine whether their classification is shared with an attribute classification of one or more manifest nodes. For example, properties and/or corresponding attribute classifications for a received resource may be analyzed against classifications for one or more manifest node attribute classifications to determine whether they share at least one of: a temporal classification, a locational classification, a concept classification, and an event classification, as well as whether they share one or more hierarchical topical classifications.

Upon determining that the received resource shares at least one classification with a manifest node, the received resource may be associated with the manifest node and a corresponding traversable relationship between the manifest node and a node generated for the received resource may be created.

From operation 608 flow continues to an end operation and the method 600 ends.

FIG. 7 is an exemplary method 700 for triggering contextual feedback related to a manifest. The method 700 begins at a start operation and continues to operation 702 where temporal and locational data is received from a computing device associated with a user or user account. For example, locational coordinates may be transmitted from a mobile computing device and geocoding may be performed to determine a specific location that a device is at. Similarly, analysis of an image may be made and a determination from that image may provide locational coordinates corresponding to the subject matter of that image. Temporal data such as a date stamp may also be received indicating a specific date and time that a mobile device is present at a specific location.

Moving from operation 702 flow continues to operation 704 where the received temporal data is processed and analysis is performed to determine whether a node associated with a manifest has been associated with a temporal feedback trigger related to temporal data received from the mobile device.

From operation 704 flow continues to operation 706 where the received locational data is processed and analysis is performed to determine whether a node associated with a manifest has been associated with a locational feedback trigger related to locational data received from the mobile device.

From operation 706 flow continues to operation 708 where determinations are made as to whether temporal and locational classification of temporal and locational data from the received resource meets a feedback trigger threshold for providing feedback related to a manifest, and at operation 710 contextual feedback is provided to a user (via a client device associated with the user or a user account) based on a determination that the feedback trigger threshold has been met.

From operation 710 the method 700 continues to an end operation and the method 700 ends.

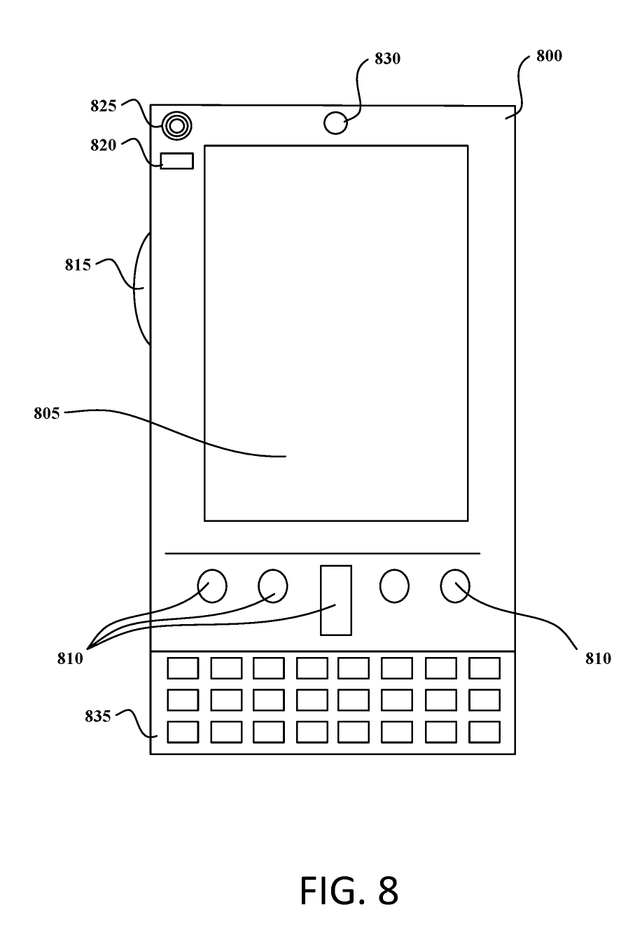

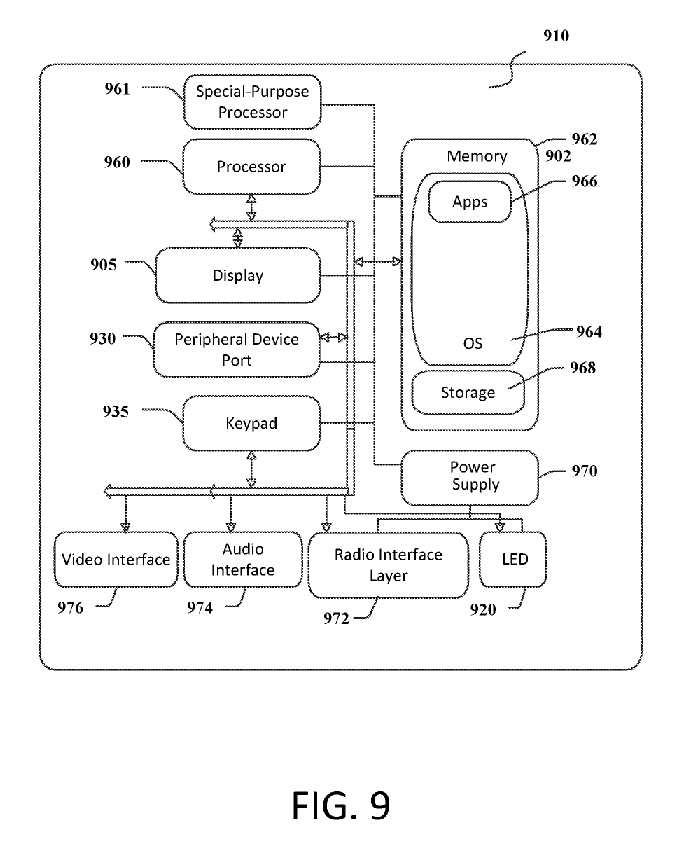

FIG. 8 and FIG. 9 illustrate computing device 800, for example, a mobile telephone, a smart phone, a tablet personal computer, a laptop computer, and the like, with which embodiments of the disclosure may be practiced. With reference to FIG. 8, an exemplary mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the computing device 800. The display 805 of the mobile computing device 800 may also function as an input device (e.g., a touch screen display). If included, an optional side input element 815 allows further user input. The side input element 815 may be a rotary switch, a button, or any other type of manual input element.

In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display.

In various embodiments, the output elements include the display 805 for showing a graphical user interface (GUI), a visual indicator 820 (e.g., a light emitting diode) and/or an audio transducer 825 (e.g., a speaker). In some embodiments, the mobile computing device 800 incorporates a vibration transducer for providing the user with tactile feedback. In yet another embodiments, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In embodiments, the word processing application may be displayed on the display 805.

FIG. 9 is a block diagram illustrating the architecture of one embodiment of a mobile computing device. That is, the mobile computing device 900 can incorporate a system (i.e., an architecture) 902 to implement some aspects of the disclosure. In one aspect the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and a wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, diagramming applications, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like.

A synchronization application (not shown) also resides on the system 902 and is programmed to interact with a corresponding synchronization application resident on a host computer to keep the information stored in the non-volatile storage area 968 synchronized with corresponding information stored in the host computer. As should be appreciated, other applications may be loaded into the memory 962 and run on the mobile computing device 900, including steps and methods for providing personalized feedback from voice analysis and other user input.

The system 902 has a power supply 970, which may be implemented as one or more batteries. The power supply 970 might further include an external power source, such as an AC adapter or a powered docking cradle that supplements or recharges the batteries.

The system 902 may also include a radio 972 that performs the functions of transmitting and receiving radio frequency communications. The radio 972 facilitates wireless connectivity between the system 902 and the “outside world,” via a communications carrier or service provider. Transmissions to and from the radio 972 are conducted under control of the operating system 964. In other words, communications received by the radio 972 may be disseminated to the application programs 966 via the operating system 964, and vice versa. The radio 972 allows the system 902 to communicate with other computing devices such as over a network. The radio 972 is one example of communication media. Communication media may typically be embodied by computer readable instructions, data structures, program modules, or other data in a modulated data signal, such as a carrier wave or other transport mechanism, and includes any information deliver media. The term “modulated data signal” means a signal that has one or more of its characteristics set or changed in such a manner as to encode information in the signal. By way of example, not limitation, communication media includes wired media such as a wired network or direct-wired connection, and wireless media such as acoustic, RF infrared and other wireless media. The term computer readable media is used herein includes both storage media and communication media.

This embodiment of the system 902 provides notifications using the visual indicator 820 that can be used to provide visual notifications and/or an audio interface 974 producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present invention, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968. Computer storage media may include volatile and nonvolatile, removable and non-removable media implemented in any method or technology for storage of information, such as computer readable instructions, data structures, program modules, or other data.

Data/information generated or captured by the mobile computing device 900 and stored via the system 902 may be stored locally on the mobile computing device 900, as described above, or the data may be stored on any number of storage media that may be accessed by the device via the radio 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio 972 or via a distributed computing network. Similarly, such data/information may be readily transferred between computing devices for storage and use according to well-known data/information transfer and storage means, including electronic mail and collaborative data/information sharing systems.

One of skill in the art will appreciate that the scale of systems such as system 902 may vary and may include more or fewer components than those described in FIG. 9. In some examples, interfacing between components of the system 902 may occur remotely, for example where components of system 902 may be spread across one or more devices of a distributed network. In examples, one or more data stores/storages or other memory are associated with system 902. For example, a component of system 902 may have one or more data storages/memories/stores associated therewith. Data associated with a component of system 902 may be stored thereon as well as processing operations/instructions executed by a component of system 902.

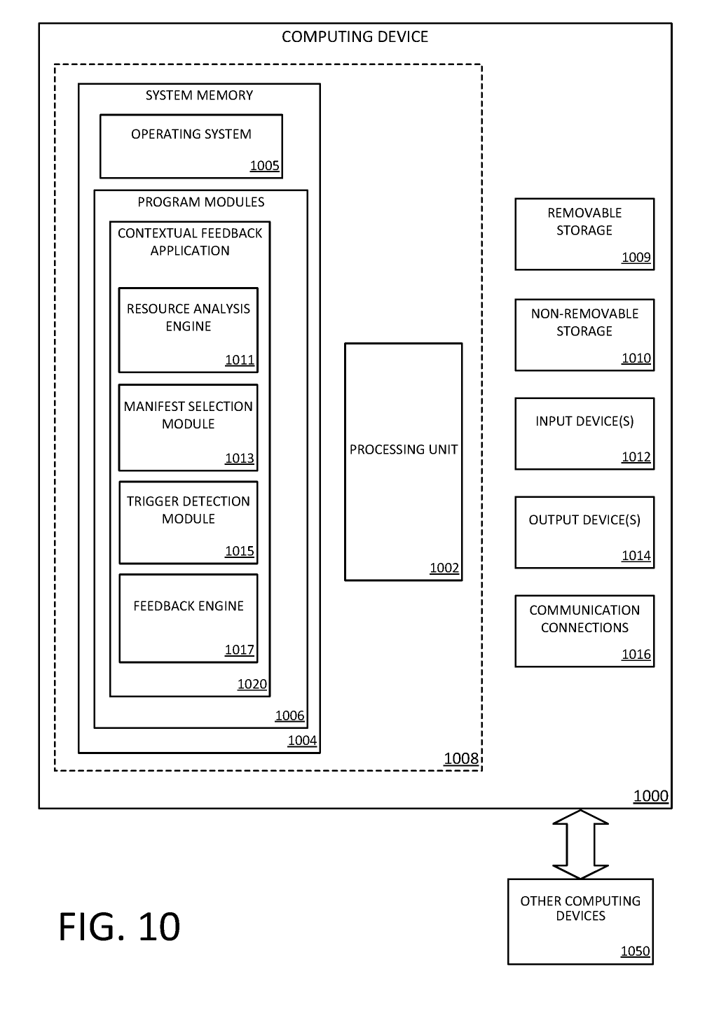

FIG. 10 is a block diagram illustrating physical components (e.g., hardware) of a computing device 1000 with which aspects of the disclosure may be practiced. In some examples, computing device components described below may have computer executable instructions for analyzing a plurality of contextual attributes associated with a resource; identifying a most relevant manifest node that shares at least one contextual attribute with at least one of the plurality of contextual attributes, the identified manifest node related to one of: a concept manifest, and an event manifest; generating a traversable relationship between the identified manifest node and a context node corresponding to the resource; associating a contextual trigger for providing feedback related to the identified manifest node with the context node corresponding to the resource; receiving a triggering input related to the contextual trigger; and providing contextual feedback related to the identified manifest node, the contextual feedback comprising information extracted from the resource. In additional examples, the computing device components described below may have computer executable instructions for: receiving a triggering input related to a contextual trigger; analyzing a plurality of attributes associated with a resource; identifying, based on the analysis, at least one traversable relationship between the resource and a manifest node, wherein the traversable relationship is associated with at least one attribute that is shared between the manifest node and the resource; and providing feedback related to the identified manifest node.

In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for contextual feedback application 1020, such as one or more components in regards to FIG. 10 and, in particular, resource analysis engine 1011, manifest selection module 1013, trigger detection module 1015, and feedback engine 1017.

The operating system 1005, for example, may be suitable for controlling the operation of the computing device 1000. Furthermore, aspects of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., contextual feedback application 1020) may perform processes including, but not limited to, the aspects, as described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 1004. While executing on processing unit 1002, program modules (e.g., applications, Input/Output (I/O) management, and other utilities) may perform processes including, but not limited to, one or more of the operational stages of the methods described herein.

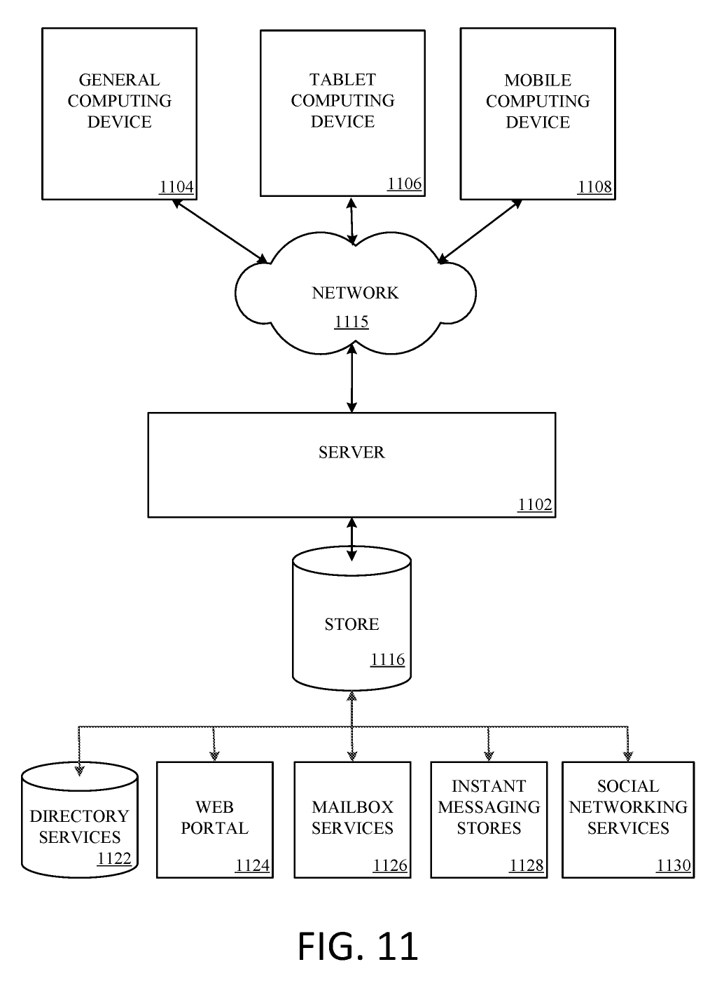

FIG. 11 illustrates one example of the architecture of a system for triggering contextual feedback related to a manifest. User input may be accessed, interacted with, or edited in association with programming modules 1006 and storage/memory which may be stored in different communication channels or other storage types. For example, various documents may be stored using a directory service 1122, a web portal 1124, a mailbox service 1126, an instant messaging store 1128, or a social networking site 1130, application 1006, an 10 manager, other utilities and storage systems may use any of these types of systems or the like for enabling data utilization, as described herein. A server 1102 may provide a storage system for use by a client operating on a general computing device 1104 and mobile computing devices 1106 through network 1115. According to examples, a resource may be generated on general computing device 1104 and accessed by a user via one or more mobile computing device 1106. One or more nodes, such as a manifest nodes and contextual nodes, and their corresponding attributes and contextual attribute classifications may be stored on server 1102 and relationships amongst manifest nodes and contextual nodes having matching attribute classifications may be identified by processing performed by server 1102. According to additional examples, network 1115 may comprise the Internet or any other type of local or wide area network, and client nodes may be implemented as a computing device embodied in a personal computer, a tablet computing device 1106, and/or by a mobile computing device 1108 (e.g., mobile processing device). Any of these examples of the computing devices described herein may obtain content from the store 1116.

As will be understood from the foregoing disclosure, certain aspects of the technology relate to a method for triggering contextual feedback related to a manifest, comprising: receiving a triggering input related to a contextual trigger; analyzing a plurality of attributes associated with a resource; identifying, based on the analysis, at least one traversable relationship between the resource and a manifest node, wherein the traversable relationship is associated with at least one attribute that is shared between the manifest node and the resource; and providing feedback related to the identified manifest node. In some examples the identified manifest node is a most relevant manifest node of a plurality of manifest nodes that share at least one attribute with the resource. In other examples the most relevant manifest node is identified based on ranking the plurality of manifest nodes according to a locational attribute that they have in common with a locational attribute associated with the resource. In still other examples the most relevant manifest node is identified based on ranking the plurality of manifest nodes according to a temporal attribute that they have in common with a temporal attribute associated with the resource. According to some aspects the at least one attribute is selected from: a temporal attribute, a locational attribute, a conceptual attribute, and an event attribute. In additional examples the at least one attribute comprises a user-defined conceptual attribute indicating that the resource is related to a manifest concept. In other examples the at least one attribute comprises a user-defined event attribute indicating that the resource is related to a manifest event. In yet other examples the contextual trigger is associated with a context node that represents at least one attribute of the resource. In some examples the contextual trigger is configured to provide feedback associated with the context node when one or more locational indicators are received that correspond to a locational attribute of the identified manifest node. In additional examples the contextual trigger is configured to provide feedback associated with the context node when one or more temporal indicators are received that correspond to a temporal attribute of the identified manifest node. In some examples providing the feedback related to the identified manifest node comprises at least one of: causing information extracted from the resource to be displayed, causing the resource to be displayed, and providing an actionable link for accessing the resource.

Additional aspects of the technology relate to a system for triggering contextual feedback related to a manifest, comprising: a memory for storing executable program code; and a processor, functionally coupled to the memory, the processor being responsive to computer-executable instructions contained in the program code and operative to: receive a triggering input related to a contextual trigger; analyze a plurality of attributes associated with a resource; identify, based on the analysis, at least one traversable relationship between the resource and a manifest node, wherein the traversable relationship is associated with at least one attribute that is shared between the manifest node and the resource; and provide feedback related to the identified manifest node. According to examples the identified manifest node is a most relevant manifest node of a plurality of manifest nodes that share at least one attribute with the resource. In additional examples the most relevant manifest node is identified based on ranking the plurality of manifest nodes according to a locational attribute that they have in common with a locational attribute associated with the resource. In other examples the most relevant node is identified based on ranking the plurality of manifest nodes according to a temporal attribute that they have in common with a temporal attribute associated with the resource. In still other examples the processor is further responsive to the computer-executable instructions contained in the program code and operative to: provide feedback associated with a context node that represents at least one attribute of the resource when one or more locational indicators are received that correspond to a locational attribute of the identified manifest node.

Additional aspects of the technology relate to a computer-readable storage device comprising executable instructions, that when executed by a processor, assist with triggering contextual feedback related to a manifest, the computer-readable storage device including instructions executable by the processor for: receiving a triggering input related to a contextual trigger; analyzing a plurality attributes associated with a resource; identifying, based on the analysis, at least one traversable relationship between the resource and a manifest node, wherein the traversable relationship is associated with at least one attribute that is shared between the manifest node and the resource; and providing feedback related to the identified manifest node. In some examples the instructions are further executable by the processor for: providing feedback associated with a context node that represents at least one attribute of the resource when one or more locational indicators are received that correspond to a locational attribute of the identified manifest node. In other examples the at least one attribute is selected from: a temporal attribute, a locational attribute, a conceptual attribute, and an event attribute. In yet other examples the identified manifest node is a most relevant manifest node of a plurality of manifest nodes that share at least one attribute with the resource.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method for triggering contextual feedback related to a manifest, comprising:
receiving a triggering input related to a contextual trigger;
analyzing a plurality of attributes associated with a resource;
identifying, based on the analysis, at least one traversable relationship between the resource and a manifest node, wherein the traversable relationship is associated with at least one attribute that is shared between the manifest node and the resource; and
providing feedback related to the identified manifest node.

2. The method of claim 1, wherein the identified manifest node is a most relevant manifest node of a plurality of manifest nodes that share at least one attribute with the resource.

3. The method of claim 2, wherein the most relevant manifest node is identified based on ranking the plurality of manifest nodes according to a locational attribute that they have in common with a locational attribute associated with the resource.

4. The method of claim 2, wherein the most relevant manifest node is identified based on ranking the plurality of manifest nodes according to a temporal attribute that they have in common with a temporal attribute associated with the resource.

5. The method of claim 1, wherein the at least one attribute is selected from: a temporal attribute, a locational attribute, a conceptual attribute, and an event attribute.

6. The method of claim 1, wherein the at least one attribute comprises a user-defined conceptual attribute indicating that the resource is related to a manifest concept.

7. The method of claim 1, wherein the at least one attribute comprises a user-defined event attribute indicating that the resource is related to a manifest event.

8. The method of claim 1, the contextual trigger is associated with a context node that represents at least one attribute of the resource.

9. The method of claim 8, wherein the contextual trigger is configured to provide feedback associated with the context node when one or more locational indicators are received that correspond to a locational attribute of the identified manifest node.

10. The method of claim 8, wherein the contextual trigger is configured to provide feedback associated with the context node when one or more temporal indicators are received that correspond to a temporal attribute of the identified manifest node.

11. The method of claim 1, wherein providing the feedback related to the identified manifest node comprises at least one of: causing information extracted from the resource to be displayed, causing the resource to be displayed, and providing an actionable link for accessing the resource.

12. A system for triggering contextual feedback related to a manifest, comprising:
a memory for storing executable program code; and
a processor, functionally coupled to the memory, the processor being responsive to computer-executable instructions contained in the program code and operative to:
receive a triggering input related to a contextual trigger;
analyze a plurality of attributes associated with a resource;
identify, based on the analysis, at least one traversable relationship between the resource and a manifest node, wherein the traversable relationship is associated with at least one attribute that is shared between the manifest node and the resource; and
provide feedback related to the identified manifest node.

13. The system of claim 12, wherein the identified manifest node is a most relevant manifest node of a plurality of manifest nodes that share at least one attribute with the resource.

14. The system of claim 13, wherein the most relevant manifest node is identified based on ranking the plurality of manifest nodes according to a locational attribute that they have in common with a locational attribute associated with the resource.

15. The system of claim 13, wherein the most relevant node is identified based on ranking the plurality of manifest nodes according to a temporal attribute that they have in common with a temporal attribute associated with the resource.

16. The system of claim 12, wherein the processor is further responsive to the computer-executable instructions contained in the program code and operative to:
provide feedback associated with a context node that represents at least one attribute of the resource when one or more locational indicators are received that correspond to a locational attribute of the identified manifest node.

17. A computer-readable storage device comprising executable instructions, that when executed by a processor, assist with triggering contextual feedback related to a manifest, the computer-readable storage device including instructions executable by the processor for:
receiving a triggering input related to a contextual trigger;
analyzing a plurality attributes associated with a resource;
identifying, based on the analysis, at least one traversable relationship between the resource and a manifest node, wherein the traversable relationship is associated with at least one attribute that is shared between the manifest node and the resource; and
providing feedback related to the identified manifest node.

18. The computer-readable storage device of claim 17, wherein the instructions are further executable by the processor for:
providing feedback associated with a context node that represents at least one attribute of the resource when one or more locational indicators are received that correspond to a locational attribute of the identified manifest node.

19. The computer-readable storage device of claim 17, wherein the at least one attribute is selected from: a temporal attribute, a locational attribute, a conceptual attribute, and an event attribute.

20. The computer-readable storage device of claim 17, wherein the identified manifest node is a most relevant manifest node of a plurality of manifest nodes that share at least one attribute with the resource.
